(19) United States
(12) Patent Application Publication
(10) Pub. No.: US 2026/0219492 A1
(43) Pub. Date: Jul. 30, 2026

(54) MICROSCANNER FOR A PROJECTION SYSTEM

(71) Applicant: Fraunhofer-Geselischaft zur Förderung der angewandten Forschung e.V., München (DE)

(72) Inventors: Lena WYSOCKI, ltzehoe (DE); Shanshan GU-STOPPEL, ltzehoe (DE)

(21) Appl. No.: 19/146,508

(22) PCT Filed: Jan. 3, 2024
(86) PCT No.: PCT/EP2024/050072

§ 371 Date: Jul. 8, 2025

(30) Foreign Application Priority Data
Jan. 9, 2023 (DE) 10 2023 200 100.4

(51) Int. Cl. G02B 26/10; G02B 26/08

(52) U.S. Cl. CPC G02B 26/105; G02B 26/0833

(57) ABSTRACT

The present disclosure describes a microscanner (100) for a projection system for projecting Lissajous figures onto an observation field. The microscanner (100), to this end, has a deflection unit (104) for deflecting incident electromagnetic radiation, a support structure (102) and a suspension (103), which movably connects the deflection unit (104) and support structure (102). The suspension (103) has a first spring arrangement (106) and a second spring arrangement (108). The first spring arrangement (106) and the second spring arrangement (108) are configured to enable a rotational movement of the deflection unit (104) relative to the support structure (102) about a first axis of rotation (A1) and a second axis of rotation (A2), which runs perpendicular to the first axis of rotation (A1). The first spring arrangement (106) and the second spring arrangement (108) are axially symmetrical to the first axis of rotation (A1) and axially symmetrical to the second axis of rotation (A2).

The following disclosure relates to a microscanner for a projection system for projecting Lissajous figures onto an observation field.

Microscanners, also known as “MEMS scanners” or “MEMS mirrors”, are micro-electromechanical systems from the class of micromirror actuators for the dynamic modulation of electromagnetic radiation, in particular visible light. Microscanners are often used in combination with a laser, wherein they are used to deflect a laser beam generated by the laser onto an observation field, such as a projection surface. The deflection of the laser beam is realized by a rotational movement of a single mirror, which is part of the microscanner.

The fields of application for microscanners are diverse and include optical microscopy, OCT imaging, FTIR spectroscopy and imaging in the multimedia and entertainment sector. By means of the rotational movement of the mirror, the laser is deflected in the form of Lissajous figures, which has proven to be particularly advantageous for scanning the field of observation with the light of the laser.

In the fields of application mentioned above, the microscanners must enable a high temporal resolution, but requirements for spatial resolution, such as an angle of resolution, are usually low and can mainly be fulfilled by the currently available microscanners. However, the advent of Light Detection and Ranging (LiDaR) technology has greatly increased the demands on microscanners. For use with LiDaR technology, microscanners must now not only provide a high temporal resolution, but also a high spatial resolution.

The prior art is described in Gu-Stoppel et al, “Design, fabrication and characterization of low-voltage piezoelektric two-axis gimbal-less microscanner”, Transducers Eurosensors XXVII: The 17th International Conference on SolidState Sensors, Actuators, and Microsystems (Transducers Eurosensors XXVII), June 2013, pp. 2489-2492 proposed a microscanner that may be rotated about two axes of rotation by means of four actuators.

The object of the present disclosure is to provide a further improved microscanner. This object is achieved by a microscanner according to claim 1.

The microscanner according to claim 1 is suitable for use in a projection system for projecting Lissajous figures onto an observation field. For this purpose, the microscanner has a deflection unit for deflecting incident electromagnetic radiation, a support structure and a suspension, which movably connects the deflection unit and support structure. The suspension comprises a first spring arrangement and a second spring arrangement. The first spring arrangement is configured to enable a rotational movement of the deflection unit relative to the support structure about a first axis of rotation. The second spring arrangement is configured to enable a rotational movement of the deflection unit relative to the support structure about a second axis of rotation, which runs perpendicular to the first axis. Furthermore, the first spring arrangement and the second spring arrangement are also axially symmetrical to the first axis of rotation and axially symmetrical to the second axis of rotation.

The microscanner described is a biaxial MEMS mirror of which the suspension enables resonant oscillation of the deflection unit about both axes of rotation. The described axially symmetrical arrangement of the first spring arrangement and the second spring arrangement to both axes of rotation, i.e. to the first axis of rotation and to the second axis of rotation, typically enables a reduction of a mechanical coupling between a rotational movement of the deflection unit about the first axis of rotation and a rotational movement of the deflection unit about the second axis of rotation.

The microscanner according to Gu-Stoppel et al. described in the introduction does not have such a symmetry. In the microscanner shown by Gu-Stoppel et al. in the prior art, it can be observed that a rotational oscillation about a first axis of rotation also influences a rotational oscillation about a second axis of rotation. This non-linearity generally leads to a convergence of the two oscillation frequencies and consequently to a cushion-shaped distortion of the Lissajous figures. This is particularly problematic if the microscanner is operated in such a way that a rotational frequency of one rotational oscillation is close to a rotational frequency of the other rotational oscillation.

Another advantage of the design of the microscanner according to claim 1 is that design modifications to one of the spring arrangements do not generally affect the vibration behaviour of the other spring arrangement and thus a respective natural frequency of the spring arrangements may be changed independently of one another. This enables greater design flexibility.

Further embodiments of the microscanner are described below.

In one embodiment, the suspension is a gimbal-less suspension. A gimbal is a pivot mounting in which an object may be rotatably suspended and which itself is also rotatably mounted. This makes it possible to rotate the object about two or more axes of rotation. This type of suspension is also known as a Cardan suspension. A suspension that may be described as gimballess allows rotation about two or more axes of rotation without the use of a pivot mounting. In other words, it is a non-Cardan suspension. A gimbal-less suspension is advantageous because it typically requires less space than a Cardan suspension.

In another embodiment, alternatively or additionally, a distance between an attachment point of the deflection unit, at which the deflection unit is mechanically connected to one of the spring arrangements, and one of the axes of rotation and/or a distance between an attachment point, at which the support structure is mechanically connected to one of the spring arrangements, and one of the axes of rotation is not greater than ¼ of a diameter of the deflection unit. This specification typically ensures that segments of the respective spring arrangement only experience one type of movement, i.e. either bending or torsion. The term distance is to be understood as the shortest distance, such as the perpendicular. In a variant of this embodiment, all attachment points of the deflection unit fulfil this requirement.

In the following, embodiments are described which have different configurations of the first spring arrangement and the second spring arrangement. These configurations may be advantageous in order to further reduce the mechanical coupling between the rotational movements.

In one of these embodiments of the microscanner, the first spring arrangement is alternatively or additionally mechanically connected to the second spring arrangement only by coupling it to the support structure and by coupling it to the deflection unit. In other words, there is no direct mechanical connection between the first spring arrangement and the second spring arrangement. This is also a feature of the gimbal-less suspension.

In another embodiment, alternatively or additionally, each spring arrangement comprises a plurality of spring elements, wherein each spring element has a spring portion extending around an edge of the deflection unit enclosing the deflection unit and having a plurality of connecting portions, and wherein a respective connecting portion mechanically connects the enclosing spring portion to either the deflection unit or the support structure. The edge of the deflection unit here refers to the end of the deflection unit in a plane spanned by the support structure. Furthermore, the word “enclosing” means that the spring portions at least partially surround the deflection unit in the spanned plane due to their course along the edge. In a variant of this embodiment, the enclosing spring portions extend around approximately a quarter of a circumference of the deflection unit. In another variant, alternatively or additionally, exactly one spring element for each spring arrangement is arranged in each quadrant of the reference system spanned by the axes of rotation.

In a further variant of this embodiment, the spring elements are alternatively or additionally mechanically connected only via the deflection unit and the support structure, but not directly.

In another variant of this embodiment, at an attachment point between the enclosing spring portion and the connecting portion, the enclosing spring portion runs approximately perpendicular to the connecting portion. Vertical here means at an angle of approximately 90° in the plane spanned by the support structure. If the spring portions run in an arc along the edge of the deflection unit, the connecting portions run approximately perpendicular to the tangent of the spring portions at the attachment point. There may be deviations from the 90° if the arcuate spring portion does not end at the level of one of the axes of rotation.

In another variant of this embodiment, a transition between an enclosing spring portion and an adjacent connecting portion is alternatively or additionally rounded. The rounding may reduce mechanical stress on the spring assemblies due to material stress. In another variant, all these transitions are alternatively rounded.

In a further variant, alternatively or additionally for a respective spring element, connecting portions for connecting the enclosing spring portion to the deflection unit run perpendicular to connecting portions for connecting the enclosing spring portion to the support structure. This orientation of the connecting portions in relation to each other is typically advantageous for efficient mechanical power transmission.

In another variant, spring elements of the first spring arrangement alternatively or additionally have inner connecting portions, which connect the enclosing spring portion to the deflection unit, running parallel to the first axis of rotation and/or outer connecting portions, which connect the enclosing spring portion to the support structure, running perpendicular to the first axis of rotation. In a further variant, spring elements of the second spring arrangement alternatively or additionally have inner connecting portions, which connect the enclosing spring portion to the deflection unit, perpendicular to the second axis of rotation, and/or outer connecting portions, which connect the enclosing spring portion to the support structure, parallel to the second axis of rotation. In these two variants, the term vertical also refers to an angle of approximately 90° within a plane spanned by the support structure.

In other variants of the embodiment, alternatively or additionally, a lateral width of a given enclosing spring portion is greater than a thickness of this enclosing spring portion and/or a lateral width of a given connecting portion is greater than a thickness of this connecting portion. The lateral width refers to the width of the enclosing spring portion or the connecting portion in a plane spanned by the support structure. The thickness denotes a length dimension of the enclosing spring portion or the connecting portion perpendicular to this plane. This ratio is typically advantageous so that maximum material stress due to movement of the spring or connection portion does not occur on high-rate etched side walls of the spring or connection portion, but on polished top and bottom surfaces, as the high-rate etched side walls are generally more susceptible to cracking.

In another embodiment of the microscanner, the first spring arrangement alternatively or additionally comprises a plurality of spring elements, in particular four spring elements, wherein each spring element comprises a spring portion with two ends extending around an edge of the deflection unit enclosing the deflection unit, wherein the spring portion is connected at one end to the deflection unit by means of an inner connecting portion and which is connected at another end to the support structure by means of an outer connecting portion. In a variant of this embodiment, inner connecting portions of the first spring arrangement run parallel to the first axis of rotation and/or outer connecting portions of the first spring arrangement run perpendicular to the first axis of rotation. In another variant, the inner connecting portions are alternatively or additionally arranged at the end of a spring element of the first spring arrangement that is closer to the first axis of rotation and/or outer connecting portions of the first spring arrangement are arranged at the end of a spring element that is further away from the first axis of rotation.

In a further embodiment, the second spring arrangement alternatively or additionally comprises a plurality of spring elements, in particular four spring elements, wherein each spring element comprises an enclosing spring portion with two ends extending around an edge of the deflection unit, wherein one end is connected to the deflection unit by means of an inner connecting web and the other end is connected to the support structure by means of an outer connecting web. In a variant of this embodiment the inner connecting portions of the second spring arrangement extend perpendicular to the second axis of rotation and/or the outer connecting portions of the second spring arrangement extend parallel to the second axis of rotation. In another variant, the inner connecting portions are alternatively or additionally arranged at the end of a spring element of the second spring arrangement that is further away from the second axis of rotation and/or outer connecting portions of the second spring arrangement are arranged at the end of a spring element that is closer to the second axis of rotation.

In one embodiment, the deflection unit alternatively or additionally has a round shape. In a variant of this embodiment in which one of the spring arrangements has a spring element with an enclosing spring portion, the enclosing spring portion runs in an arc along the edge of the deflection unit. In another embodiment, the deflection unit alternatively or additionally has a diameter in a range from 2 to 8 mm, in particular a diameter of 6 mm.

In a further embodiment, a material composition of the microscanner alternatively or additionally comprises silicon, in particular polysilicon. In another embodiment, the deflection unit has one or more dielectric layers for reflecting electromagnetic radiation.

Furthermore, in another embodiment, the support structure and spring arrangements alternatively or additionally have a thickness of 20 μm to 120 μm. In other embodiments, the deflection unit alternatively or additionally has a thickness of up to 1 mm.

In a variant of an embodiment comprising a spring arrangement with connecting portions, these are formed as connecting webs. A connecting web is distinguished by a predominantly elongate shape.

In the following, embodiments are described which comprise an actuator arrangement with which the deflection unit may be set in rotation by means of the spring arrangements.

In one of these embodiments the microscanner alternatively or additionally comprises a first actuator arrangement which is configured to deflect the deflection unit about the first axis of rotation by means of the first spring arrangement and/or a second actuator arrangement which is configured to deflect the deflection unit about the second axis of rotation by means of the second spring arrangement. By using two separately controllable actuator arrangements, a rotational movement about the first axis of rotation and about the second axis of rotation may be initiated and controlled in a targeted manner. The deflection enables the excitation of a rotational oscillation about the axis of rotation. In a variant of this embodiment, the first actuator arrangement and/or the second actuator arrangement is configured to bend at least a part of the respective spring arrangement in a direction perpendicular to a plane that is spanned by the support structure, in order to deflect the deflection unit.

In another embodiment, a first actuator arrangement is alternatively or additionally arranged on spring portions of the first spring arrangement extending along an edge of the deflection unit and enclosing the deflection unit and/or a second actuator arrangement is arranged on spring portions of the second spring arrangement extending along an edge of the deflection unit and enclosing the deflection unit. The arrangement of the actuator arrangements on the arcuate portions may be advantageous for generating the rotational movement about the first axis of rotation and about the second axis of rotation.

In order to generate the rotational movement of the deflection unit, the first actuator arrangement is additionally or alternatively configured to bend that part of the first spring arrangement on one side of the first axis of rotation in a direction perpendicular to the plane spanned by the support structure and to bend that part of the first spring arrangement on the other side of the first axis of rotation in the opposite direction. Similarly, the second actuator arrangement is configured to bend that part of the second spring arrangement on one side of the second axis of rotation in a direction perpendicular to the plane spanned by the support structure and to bend that part of the second spring arrangement on the other side of the second axis of rotation in the opposite direction. In variants in which the actuators are only arranged on the enclosing spring portions, only these are bent by the actuators.

In a variant of the two embodiments described above, at least one of the actuator arrangements has a piezoelectric actuator, a thermoelectric actuator, a magnetic actuator and/or an electrostatic actuator.

In a variant of one of the embodiments described above, which has an actuator arrangement, the actuator arrangement is axially symmetrical to both axes of rotation. In a variant that has two actuator arrangements, both actuator arrangements are alternatively or additionally configured to be axially symmetrical to both axes of rotation.

In the following, exemplary embodiments of the microscanner according to the present disclosure are described with reference to the figures. An overview of the figures is given first.

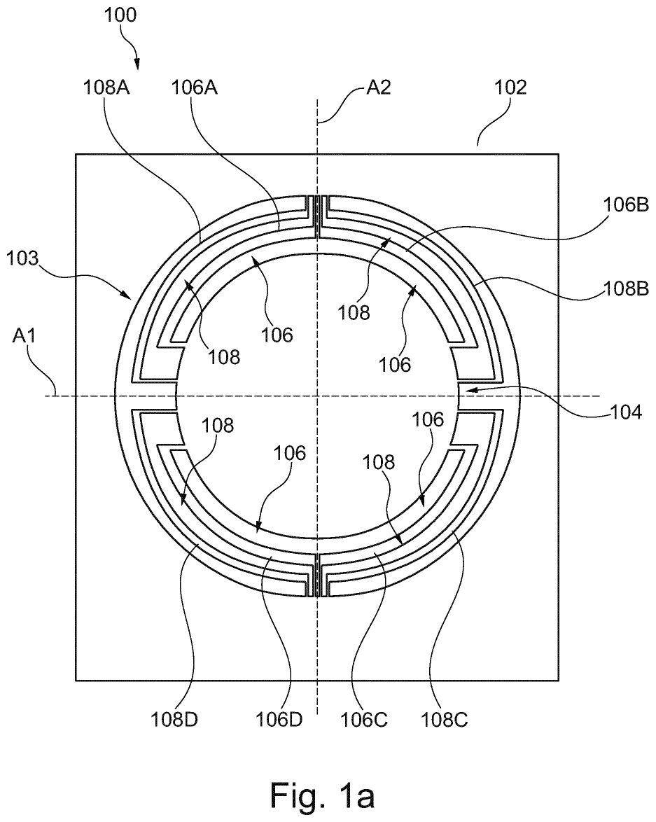

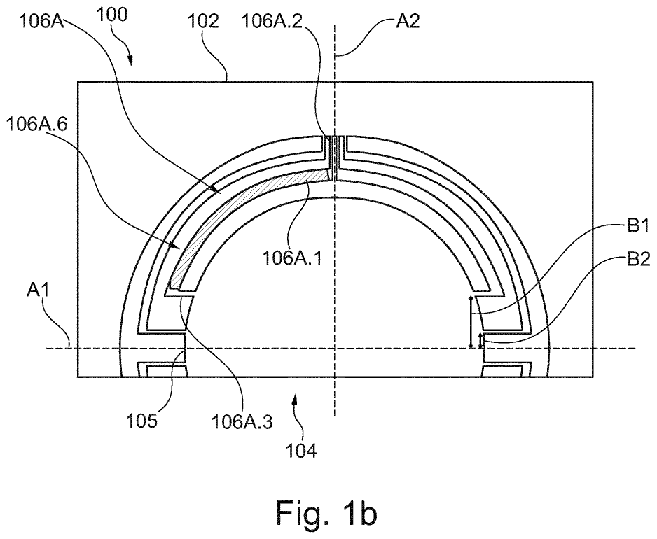

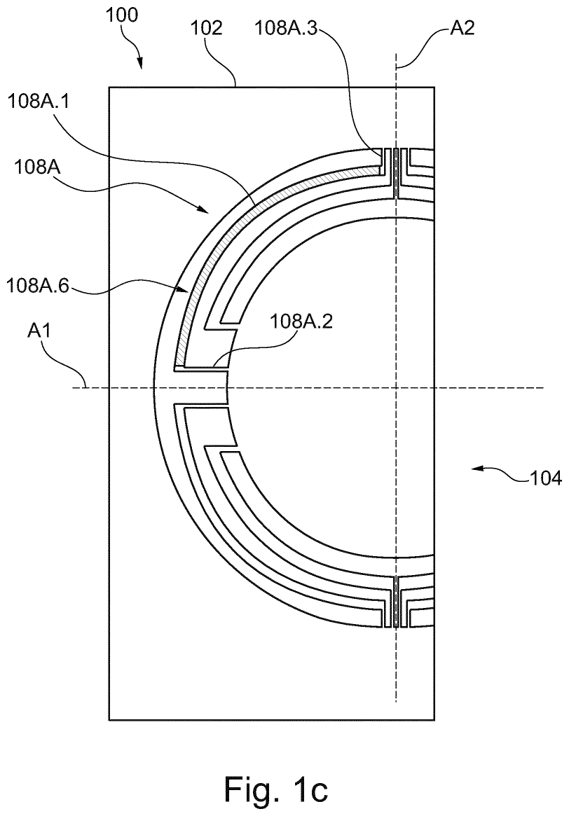

FIG. 1a shows a microscanner with two spring arrangements for a projection system for projecting Lissajous figures onto an observation field;

FIG. 1b shows a first enlarged detail of the microscanner from FIG. 1a focussing on a first spring arrangement;

FIG. 1c shows a second enlarged detail of the microscanner from FIG. 1a focussing on a second spring arrangement;

FIG. 1d shows a side view of the microscanner from FIG. 1a;

FIG. 1e shows an enlarged view of the microscanner from FIG. 1a in side view;

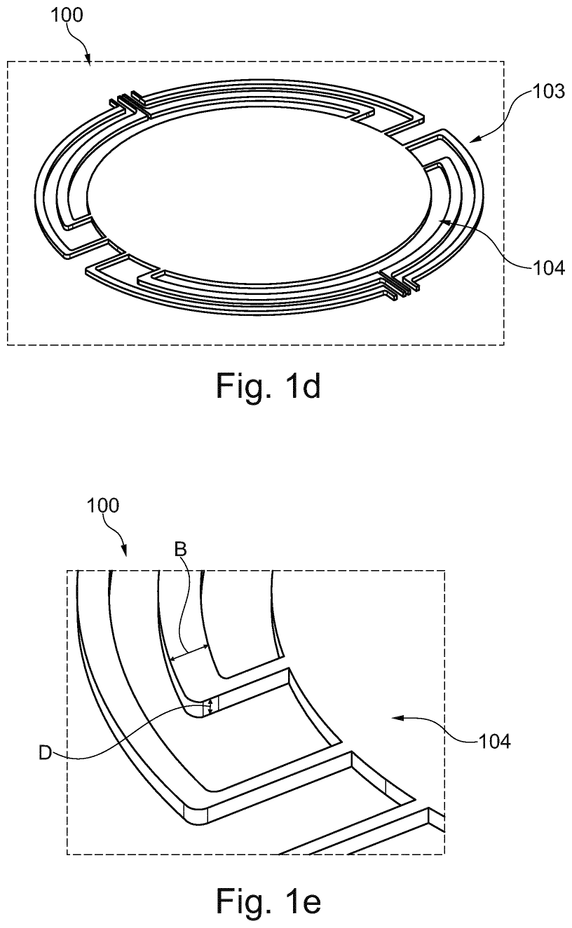

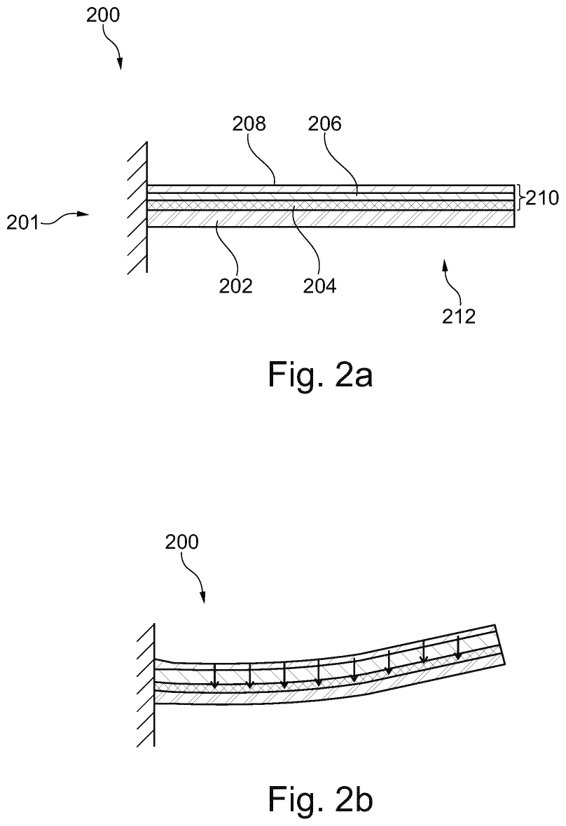

FIG. 2a shows a schematic structure of a piezoelectric actuator arrangement as used in the microscanner shown in FIG. 1a when it is in the rest state;

FIG. 2b shows the piezoelectric actuator arrangement from FIG. 2a in the deflected state;

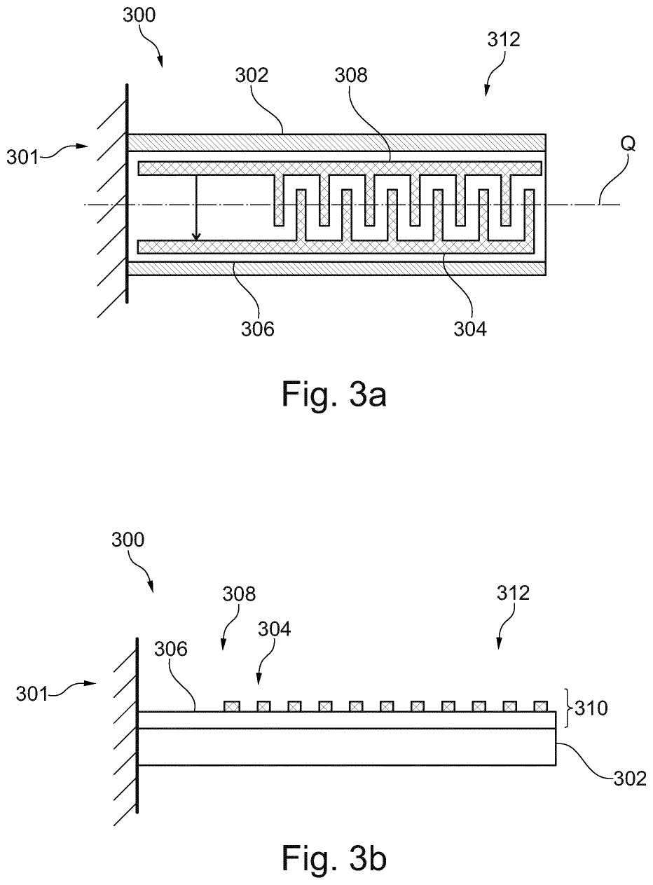

FIG. 3a shows a top view of a second piezoelectric actuator arrangement, as can also be used with the microscanner shown in FIG. 1a; and

FIG. 3b shows a cross-section of the actuator arrangement shown in FIG. 3a.

The exemplary embodiments shown in the figures are described in detail below. The same reference signs are used in the figures to identify identical components.

First of all, an exemplary embodiment of a microscanner is described on the basis of FIGS. 1a-e. FIG. 1a shows a microscanner 100 with two spring arrangements for a projection system for projecting Lissajous figures onto an observation field. FIG. 1b shows a first enlarged detail of the microscanner 100 from FIG. 1a focussing on a first spring arrangement 106. FIG. 1c shows a second enlarged detail of the microscanner 100 from FIG. 1a focussing on a second spring arrangement 108. FIG. 1d shows a side view of the microscanner 100 from FIG. 1a. FIG. 1e shows an enlarged view of the microscanner 100 from FIG. 1a in side view. All of FIGS. 1a-c show the microscanner in a top view, i.e. looking at a reflective side of a mirror 104 of the microscanner 100. FIG. 1d and FIG. 1e show the microscanner 100 without the support structure.

The microscanner 100 is made from a silicon wafer. The microscanner shown in FIGS. 1a-e is polycrystalline silicon with a thickness D of 80 μm. The thickness D here refers to a dimension of the microscanner in a direction perpendicular to the plane spanned by the support structure 102. Further dielectric layers are applied to a mirror 104 of the microscanner, so that this has a total layer thickness of up to 1 mm.

The microscanner 100 comprises the mirror 104 as deflection unit for deflecting incident electromagnetic radiation, the support structure 102 and a suspension 103, which movably connects the deflection unit 104 and support structure 102. The deflection unit 104 is approximately circular in shape. In other exemplary embodiments, however, other forms of the deflection unit are also realized.

The suspension 103 has two spring arrangements: a first spring arrangement 106 and a second spring arrangement 108. The first spring arrangement 106 is configured to enable a rotational movement of the deflection unit 104 relative to the support structure 102 about a first axis of rotation A1, which in FIGS. 1a-c runs horizontally. The second spring arrangement 108 is configured to enable a rotational movement of the deflection unit 104 relative to the support structure 102 about a second axis of rotation A2, which runs perpendicular to the first axis of rotation A1. Both spring arrangements, i.e. the first spring arrangement 106 and the second spring arrangement 108 are axially symmetrical to the first axis of rotation A1 and axially symmetrical to the second axis of rotation A2.

The suspension 103 of the microscanner 100 is a non-Cardan suspension. This type of suspension is often referred to as gimballess suspension. In a Cardan suspension, an object, such as the deflection unit, is rotatably mounted in a pivot mounting, wherein the pivot mounting itself is also rotatably mounted.

In contrast, the suspension 103 does not use a rotatably mounted pivot mounting. Rather, the rotation about the two axes of rotation A1, A2 is achieved by means of the spring arrangements 106 and 108, both of which are directly mechanically connected to the support structure 102 and the deflection unit 104.

In the exemplary embodiment of the microscanner 100 shown in FIGS. 1a-e, the first spring arrangement 106 comprises four spring elements 106A-D. Due to the axially symmetrical embodiment of the first spring arrangement 106, the spring elements are identical. In the following, therefore, only the spring element 106A is described in detail with reference to FIG. 1b. The spring element 106A comprises an enclosing spring portion 106A.1, which is connected at one end to the deflection unit 104 by means of an inner connecting portion 106A.3 in the form of a connecting web, and at the opposite end is connected to the support structure 102 by means of an outer connecting portion 106A.2, also in the form of a connecting web. The enclosing spring portion 106A.1 extends in an arc around an edge 105 of the deflection unit 104 and is referred to below for simplification only as the arcuate spring portion 106A.1. The Inner connecting web 106A.3 runs parallel to the first axis of rotation A1 and the outer connecting web 106A.2 runs perpendicular to the first axis of rotation A1. The deflection unit 104 is rotated about the axis of rotation A1 by means of the spring arrangement 106 by bending the arcuate spring portion of the spring elements 106A and 106D in a direction perpendicular to the plane spanned by the support structure 102 and by bending the arcuate spring portion of the spring elements 106B and 106C in a direction opposite to this direction.

The second spring arrangement 108 also comprises four spring elements 108A-D, the embodiment of which is explained in more detail below with reference to the spring element 108A shown in FIG. 1c. The spring element 108A comprises an enclosing spring portion 108A.1, wherein one end of the enclosing spring portion 108A.1 is connected to the deflection unit 104 by means of an Inner connecting portion 108A.2, here a connecting web, and another end of the enclosing spring portion 108A.1 is connected to the support structure 102 by means of an outer connecting portion 108A.3, also a connecting web. The enclosing spring portion 108A.1 also extends in an arc around the edge 105 of the deflection unit 104 and is also referred to below simply as the arcuate spring portion 108A.1. The inner connecting web 108A.2 of the spring element 108A runs perpendicular to the second axis of rotation A2 and the outer connecting web 108A.3 of the spring element 108A runs parallel to the second axis of rotation A2. The deflection unit 104 is rotated about the axis of rotation A2 by bending the arcuate spring portions of the spring elements 108A and 108D in a direction perpendicular to the plane spanned by the support structure 102, while the arcuate spring portions of the spring elements 108B and 108C are bent in a direction opposite thereto. However, the described relationship between the spring arrangement 106 and 108 and the two axes of rotation is only an exemplary configuration. If the spring elements of the spring arrangements 106 and 108, which are bent in pairs in the same direction, are adapted accordingly, it is also possible to generate a rotational movement about the second axis of rotation A2 by means of the spring arrangement 106 and to generate a rotational movement about the first axis of rotation A1 by means of the spring arrangement 108.

Attachment points between the inner connecting webs of the spring elements 106A-D and the deflection unit 104 as well as attachment points between the inner connecting webs of the spring elements 108A-D and the deflection unit 104 are arranged such that they have a distance B1 or a distance B2 (see FIG. 1b) of less than 1% of a diameter from the first axis of rotation A1. In addition, attachment points between the outer connecting webs of the spring elements 106A-D and the support structure 102 and attachment points between the outer connecting webs of the spring elements 108A-D and the support structure 102 are arranged such that they have a distance of less than X of a diameter from the second axis of rotation A2. Typically, each portion of a spring element undergoes only one type of movement, either bending or torsion. Furthermore, at an attachment point between the arcuate spring portion and the connecting web, the arcuate spring portion runs approximately perpendicular to the connecting web.

In the exemplary embodiment, transitions between arcuate spring portions and respectively adjacent connecting web are rounded, for example as indicated at the transition between arcuate spring segment 106A.1 and inner connecting web 106A.3 in FIGS. 1a-c and in particular FIG. 1e. This is typically advantageous in order to reduce material stress or prevent local material stress peaks and thus increase mechanical resilience. The spring elements of the second spring arrangement 108 are formed in a similar way.

In order to achieve a higher mechanical load capacity, the arcuate spring portions of the spring assemblies of the microscanner 100 have also been formed so that their lateral width B is greater than their thickness D.

As described above, the first spring arrangement 106 and the second spring arrangement 108 act as bending beams, allowing the deflection unit 104 to rotate relative to the support structure 102. In order to actively set the deflection unit 104 in rotation, the microscanner 100 comprises a first actuator arrangement and a second actuator arrangement. The first actuator arrangement is arranged on the arcuate spring portions of the first spring arrangement 106 running along the deflection unit and is configured to realize the corresponding bending of the arcuate spring portions. This is shown by way of example for the spring arrangement 106 in FIG. 1b, in which an actuator arrangement 106A.6 is indicated by means of the striped area on a surface of the arcuate spring portion 106A.1.

The second actuator arrangement is arranged on the spring portions of the second spring arrangement 108, which extend in an arc along the deflection unit 104. This is shown by way of example for the spring arrangement 108 in FIG. 1c, in which an actuator arrangement 108A.6 is indicated by means of the striped area on a surface of the arcuate spring portion 108A.1.

Both the first actuator arrangement and the second actuator arrangement comprise piezoelectric elements to realize the deflection about the respective axis of rotation. The exact structure of the actuators is described below with reference to FIG. 2a and FIG. 2b.

FIG. 2a shows a schematic structure of a piezoelectric actuator arrangement 210, as used in the microscanner shown in FIG. 1a when it is in the rest state. FIG. 2b shows the piezoelectric actuator arrangement 210 in the deflected state.

The piezoelectric actuator arrangement 210 shown in FIG. 2a and FIG. 2b is not shown as part of the microscanner 100, but is simplified to explain the mode of operation in a bending beam arrangement 200. The bending beam arrangement 200 comprises an anchor element 201 and a bending beam 212. The bending beam 212 comprises a passive support layer 202 and the actuator arrangement 210 located thereon. In the context of the microscanner 100, the support layer 202 corresponds to one of the arcuate spring portions of the first or second spring arrangement. The anchor element 201 corresponds to an outer connecting web connected to the arcuate spring portion.

The piezoelectric actuator arrangement 210 comprises three layers forming a sandwich structure. Here, an upper layer 208, which forms an upper electrode, and a lower layer 204, which forms a lower electrode, surround a middle piezoelectric layer 206. By applying a voltage between the upper layer 208 and the lower layer 204, an electric field E is formed, indicated by the arrows in FIG. 2b, which also penetrates the middle layer 206. If the piezoelectric layer 206 is suitably configured, this electric field causes the bending beam 212 to bend. This is shown in FIG. 2b. Bending in the opposite direction may be achieved by applying a voltage with the opposite sign. If the voltage is modulated sinusoidally, the beam may be set into an oscillating motion.

In the example shown, the electrodes 204 and 208 are metal. In other embodiments, however, doped semiconductor materials may also be used, for example. The piezoelectric material in the example shown in FIG. 2a and FIG. 2b is AlN. In other exemplary embodiments, however, the use of AlScN, GaN, PZT or other piezoelectric materials is also possible.

The actuator arrangement 210 is formed by two electrodes and a piezoelectric layer in a sandwich structure. In other exemplary embodiments, however, it is also possible to use interdigital electrodes, which means that no sandwich structure is required. Such an actuator arrangement is described below with reference to FIG. 3a and FIG. 3b.

FIG. 3a shows a top view of another piezoelectric actuator arrangement 310. FIG. 3b shows a cross-section of the actuator arrangement 310 shown in FIG. 3a. The cross-section shown in FIG. 3b runs along the line Q shown in FIG. 3a.

As in FIG. 2a and FIG. 2b, FIG. 3a and FIG. 3b do not show the piezoelectric actuator arrangement 310 as part of the microscanner 100, but simplified to explain the mode of operation in a bending beam arrangement 300. The bending beam arrangement 300 comprises an anchor element 301 and a bending beam 312. The bending beam 312 comprises a passive support layer 302 and the actuator arrangement 310 located thereon. In the context of the microscanner 100, the support layer 302 corresponds to one of the arcuate spring segments of the first or second spring arrangement. The anchor element 301 corresponds to an outer connecting web connected to the arcuate spring segment.

The bending beam 312 has the actuator arrangement 310 above the support layer 302. This comprises a piezoelectric layer 306 made of a piezoelectric material. This in turn has two interdigital electrodes 304 and 308, which are toothed together. If a voltage is applied between the two interdigital electrodes 304 and 308, this leads to the build-up of an electric field, which also penetrates the piezoelectric layer 306. If the piezoelectric layer 306 is configured accordingly, the bending beam may be moved upwards or downwards. A similar situation is also shown in FIG. 2b.

Instead of an actuator arrangement based on the piezoelectric effect, it is also possible to use actuators based on a thermoelectric effect. Two layers of material are applied to the arcuate spring portions, which have a different coefficient of expansion when the temperature changes, as well as a heating circuit that is configured to heat the two layers of material. When heated, the layers expand to varying degrees, which leads to a bending of the arcuate spring portion. In addition, magnetic actuators or electrostatic actuators may also be used with the spring arrangement described.

To summarize, the present disclosure describes a microscanner (100) for a projection system for projecting Lissajous figures onto an observation field. The microscanner (100), to this end, has a deflection unit (104) for deflecting incident electromagnetic radiation, a support structure (102) and a suspension (103), which movably connects the deflection unit (104) and support structure (102). The suspension (103) has a first spring arrangement (106) and a second spring arrangement (108). The first spring arrangement (106) and the second spring arrangement (108) are configured to enable a rotational movement of the deflection unit (104) relative to the support structure (102) about a first axis of rotation (A1) and a second axis of rotation (A2), which runs perpendicular to the first axis of rotation (A1). The first spring arrangement (106) and the second spring arrangement (108) are also axially symmetrical to the first axis of rotation (A1) and axially symmetrical to the second axis of rotation (A2).

1. A microscanner for a projection system for projecting Lissajous figures onto a field of observation, wherein the microscanner has:
a deflection unit for deflecting incident electromagnetic radiation,
a supporting structure and
a suspension which movably connects the deflection unit and the support structure to one another; wherein
the suspension comprises a first spring arrangement and a second spring arrangement, and
the first spring arrangement is configured to enable a rotational movement of the deflection unit relative to the support structure about a first axis of rotation, and the second spring arrangement is configured to enable a rotational movement of the deflection unit relative to the support structure about a second axis of rotation which extends perpendicularly to the first axis of rotation, wherein
the first spring arrangement and the second spring arrangement are axially symmetrical to the first axis of rotation and axially symmetrical to the second axis of rotation.

2. The microscanner according to claim 1, wherein a distance between an attachment point, at which the deflection unit is mechanically connected to one of the spring arrangements, and one of the first axis of rotation or the second axis of rotation and/or a distance between an attachment point, at which the support structure is mechanically connected to one of the spring arrangements, and one of the first axis of rotation or the second axis of rotation is not greater than ¼ of a diameter of the deflection unit.

3. The microscanner according to claim 1, wherein each spring arrangement comprises a plurality of spring elements and each spring element has a spring portion, extending around an edge of the deflection unit enclosing the deflection unit, and a plurality of connecting portions, wherein a respective connecting portion mechanically connects the enclosing spring portion either to the deflection unit or to the support structure.

4. The microscanner according to claim 3, wherein at an attachment point between the enclosing spring portion and the connecting portion, the enclosing spring portion extends approximately perpendicular to the connecting portion.

5. The microscanner according to claim 3, wherein a transition between an enclosing spring portion and an adjacent connecting portion is rounded.

6. The microscanner according to claim 3, wherein connecting portions of a respective spring element for connecting the enclosing spring portion to the deflection unit extend perpendicular to connecting portions of the respective spring element for connecting the enclosing spring portion to the support structure.

7. The microscanner according to claim 3, wherein a lateral width of a given enclosing spring portion is greater than a thickness of the given enclosing spring portion and/or a lateral width of a given connecting portion is greater than a thickness of the given connecting portion.

8. The microscanner according to claim 1, wherein the first spring arrangement comprises a plurality of spring elements, wherein each spring element comprises a spring portion with two ends, which extends around an edge of the deflection unit enclosing the deflection unit, that is connected at each end to the deflection unit by means of an inner connecting portion and is connected to the support structure by means of an outer connecting portion arranged centrally between the two ends.

9. The microscanner according to claim 8, wherein the inner connecting portion of the first spring arrangement extends parallel to the first axis of rotation and/or the outer connecting portion of the first spring arrangement extends perpendicular to the first axis of rotation.

10. The microscanner according to claim 1, wherein the second spring arrangement comprises a plurality of spring elements, wherein each spring element comprises a spring portion extending around an edge of the deflection unit enclosing the deflection unit and having two ends, wherein one end is connected to the deflection unit by means of an inner connecting portion and an other end is connected to the support structure by means of an outer connecting portion.

11. The microscanner according to claim 10, wherein the inner connecting portions of the second spring arrangement extend perpendicular to the second axis of rotation (A2) and/or the outer connecting portions of the second spring arrangement extend parallel to the second axis of rotation (A2).

12. The microscanner according to claim 1, comprising a first actuator arrangement which is configured to deflect the deflection unit about the first axis of rotation by means of the first spring arrangement and/or a second actuator arrangement which is configured to deflect the deflection unit about the second axis of rotation (A2) by means of the second spring arrangement.

13. The microscanner according to claim 1, wherein at least a part of a first actuator arrangement is arranged on spring portions of the first spring arrangement, which extend along an edge of the deflection unit enclosing the deflection unit, and/or at least a part of a second actuator arrangement is arranged on spring portions of the second spring arrangement, which extend along an edge of the deflection unit enclosing the deflection unit.

14. The microscanner according to claim 12, wherein at least one of the actuator arrangements comprises a piezoelectric actuator, a thermoelectric actuator, a magnetic actuator and/or an electrostatic actuator.

15. The microscanner according to claim 1, wherein the suspension is a gimbal-less suspension.
